(19) United States
(12) Patent Application Publication
(10) Pub. No.: US 2018/0074604 A1
(43) Pub. Date: Mar. 15, 2018

(54) FLAT MOUSE AND USAGE METHOD THEREOF

(71) Applicant: Yong Tang, Santa Clara, CA (US)

(72) Inventor: Yong Tang, Santa Clara, CA (US)

(21) Appl. No.: 15/297,652

(22) Filed: Oct. 19, 2016

(30) Foreign Application Priority Data
Sep. 14, 2016 (CN) 201610825134.6

(51) Int. Cl. G06F 3/0354; G06F 3/0484; G06F 3/041

(52) U.S. Cl. CPC G06F 3/03543; G06F 3/041; G06F 3/04845

(57) ABSTRACT

The invention provides a flat mouse, including a flat shell having a keypad area and a dragging area from the top down. The keypad area comprises the left mouse button and the right mouse button. The movement of the cursor can be achieved by pressing down and dragging the dragging area, when the cursor moves to an appropriate position the left mouse button and/or the right mouse button can be pressed by fingers while not moving wrist and elbow. In the process, only the fingers are involved to drag and press the flat mouse, the wrist and elbow are not involved, thus reducing the injury probability of the wrist, and being favorable to building up the flexibility of the fingers. Compared with conventional mouse, the flat mouse is more compact, and is more convenient for carrying.

### FIELD OF THE INVENTION

The invention relates to the field of computer input equipment, and more particularly to a flat mouse and usage method thereof.

### BACKGROUND OF THE INVENTION

With the development of computer technology, computers have become an indispensable part in daily life and work. However, the longtime use of mouse leads to various kinds of diseases. For example, mouse hand, a common modern civil disease, with symptoms of swelling, pains, spasm, paralysis of wrist muscles or joints, is caused by intensive, repetitive, and excessive activities of wrists when users use computers for a long time, type on the keyboard and operate the mouse. The causes of the disease are, on the one hand, the longtime use of the mouse, on the other hand, the defects of conventional mouse, specifically, the upper shell of the mouse is in the shape of convex arc for supporting the center of the palm. However, the arc-shaped upper shell requires the elbow as a support point, as a result, the wrist is always stressed, even at rest, the holding posture of the palm is maintained, which tends to damage the wrist muscles.

### SUMMARY OF THE INVENTION

In view of the above-described problems, it is one objective of the invention to provide a flat mouse and usage method thereof.

To achieve the above objective, the following technical solutions are provided.

A flat mouse, comprises: a flat shell comprising, from the top down, a keypad area and a dragging area, the keypad area being adapted to be pressed by fingers, the dragging area being adapted to be held down by the fingers to drag the flat mouse, and the keypad area comprising a left mouse button and a right mouse button.

Preferably, the dragging area and the keypad area are integrated.

Preferably, the dragging area and the keypad area are touch panels.

A usage method of the flat mouse, comprises: placing the fingers on the dragging area, the left mouse button and the right mouse button being reachable by the fingers; holding down the dragging area and dragging the flat mouse using the fingers until a cursor of the mouse moves to an appropriate position, and pressing the left mouse button and/or the right mouse button using the fingers.

A flat mouse, comprises: a flat shell comprising a keypad area and a dragging area from the top down, the keypad area being adapted to be pressed by fingers, the dragging area being adapted to be pressed by the fingers, the keypad area comprising a left mouse button and a right mouse button, and the dragging area being a touch panel capable of controlling the movement of a cursor.

A usage method of the flat mouse, comprises: placing the fingers on the touch panels, the left mouse button and the right mouse button being reachable by the fingers; sliding the fingers on the touch panel until the cursor of the mouse moves to an appropriate position, and pressing the left mouse button and/or the right mouse button using the fingers.

A flat mouse, comprises: a flat shell comprising a left mouse button and a right mouse button from the top down, surfaces of the left mouse button and the right mouse button being covered with a touch panel capable of controlling the movement of a cursor of the mouse.

A usage method of the flat mouse, comprises: placing the fingers on the left mouse button and the right mouse button; sliding the fingers on the touch panel of any one of the left mouse button and the right mouse button until the cursor of the mouse moves to an appropriate position, and pressing the left mouse button and/or the right mouse button using the fingers.

Preferably, edges of the flat shell are arc-shaped, end surfaces and side faces of the flat shell are in the shape of corner rounding to form a rounded arc surface, and the rounded arc surface comprises a depressed accommodation groove or a convex supporting boss.

Advantages of the flat mouse and the usage method thereof are summarized as follows. Based on the technical solutions of the invention, a user only needs to press his or her fingers on the dragging area and drag the flat mouse until the cursor of the mouse moves to an appropriate position, and then presses the left mouse button and/or the right mouse button to complete the operation. Compared with conventional mouse, the movement of the mouse of the invention can be achieved by only dragging the mouse using fingers, thus moving the cursor, other operations are the same as that for conventional mouse. In addition, compared with conventional mouse, advantages of the invention include: the flat mouse of the invention is card-type, light-weighted, and convenient for carrying. In use, the movement of the mouse is completed using fingers instead of wrists, which greatly reduces the injury of the wrists. At rest or in nonuse, the hands of users are completely relaxed in compliance with human engineering, even after long time use, the hands are not tired, and the fingers can be more flexible, which is favorable to building up the flexibility of the fingers.

### BRIEF DESCRIPTION OF THE DRAWINGS

FIG. 1 is a three-dimensional diagram (1) of a flat mouse in Embodiment 1 or 2, and also a schematic diagram of a flat mouse in Embodiment 1 or 2;

FIG. 2 is a three-dimensional diagram (2) of a flat mouse in Embodiment 1 or 2, and also a schematic diagram of a flat mouse in Embodiment 1 or 2;

FIG. 3 is a top view of a flat mouse in Embodiment 2;

FIG. 4 is a sectional view of a flat mouse taken from line A-A in FIG. 3; and

FIG. 5 is a side view of a flat mouse in Embodiment 1, 2, or 3, where edges of the shell of the mouse are arc-shaped.

In the drawings, the following reference number are used:

10. Keypad area; 11. Left mouse button; 12. Right mouse button; 20. Dragging area; 21. Touch panel; 22. Fingers; 30. Flat shell; 40. Rounded arc surface.

### DETAILED DESCRIPTION OF THE EMBODIMENTS

To further illustrate the invention, experiments detailing a flat mouse and usage method thereof are described below. It should be noted that the following embodiments are intended to describe and not to limit the invention.

### Embodiment 1

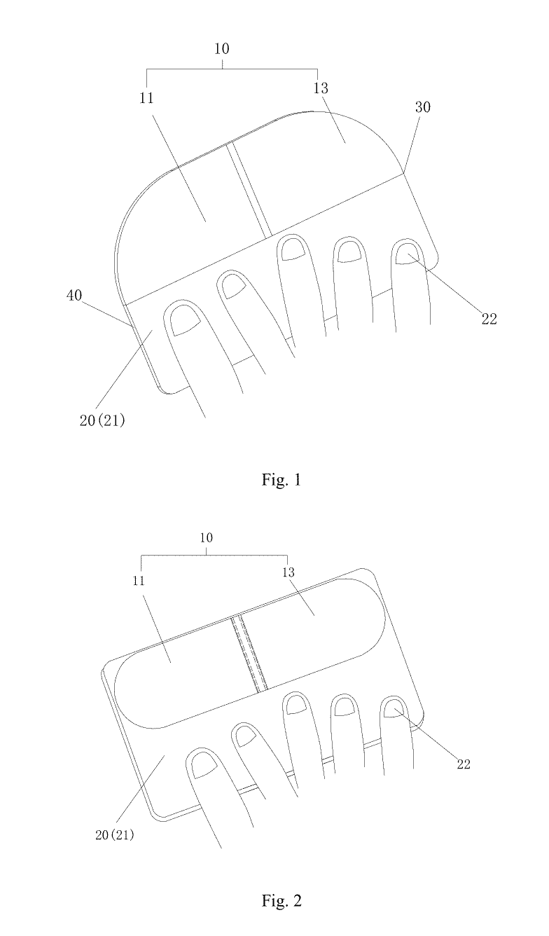

As shown in FIGS. 1-2, a flat mouse, comprises: a flat shell 30 comprising, from the top down, a keypad area 10 and a dragging area 20. The keypad area 10 is adapted to be pressed by fingers 22, and the dragging area 20 is adapted to be held down by the fingers 22 to move the flat mouse. The keypad area 10 comprises a left mouse button 11 and a right mouse button 13. In this embodiment, a middle mouse button is disposed between the left mouse button 11 and the right mouse button 13. Optionally, no middle mouse button is disposed. In addition, the flat shell 30 comprises a mouse electroplate. In this embodiment, the flat mouse comprising the left mouse button 11 and the right mouse button 13 employs a mechanical mouse to control the movement of the cursor.

In this embodiment, the operation can be achieved using at least two fingers 22, or three to five fingers 22, which are not limited in the embodiment.

In this embodiment, the movement of the mouse can be achieved by holding down the dragging area 20 using fingers 22. In the process, only the fingers 22 are stressed to drag the flat mouse, the wrist and elbow are not involved, thus reducing the injury probability of the wrist, and being favorable to building up the flexibility of the fingers 22.

To facilitate the fingers 22 to hold down the dragging area 20 and move the flat mouse, preferably, a concave groove or boss, the outline of which matches the fingers 22, is disposed in the dragging area 20. The concave groove or convex boss increases the contact area of the dragging area 20 and the fingers 22, thus simplifying the operation of the fingers 22 to move the flat mouse. In this embodiment, the dragging area 20 comprises a concave groove.

Preferably, the dragging area 20 and the keypad area 10 are integrated. Thus, the dragging area 20 and the keypad area 10 are coincident, which is favorable to increasing the strength and prolonging the service life of the flat mouse.

Preferably, the dragging area 20 and the keypad area 10 are touch panels 21. Thus, a user only needs to slide his or her fingers on the dragging area 20 to move the cursor to an appropriate position, and then click the keypad area 10. Because the keypad area is a touch panel 21, the user does not need to press the mouse heavily just like operating a mechanical mouse, only to click the keypad area 10 slightly to complete the operation.

A usage method of the flat mouse, comprises: placing the flat mouse on a plane, placing the palm on the plane and the fingers on the dragging area 20, the left mouse button 11 and the right mouse button 13 being reachable by the fingers 22; holding down the dragging area 20 and dragging the flat mouse using the fingers until the cursor of the mouse moves to an appropriate position, and pressing the left mouse button 11 and/or the right mouse button 13 using the fingers.

In a relaxed state, the fingers of a user lay flat or naturally curve on the flat mouse. As needed, the fingers are placed on the dragging area 20 and the keypad area 10, and hold down and drag the dragging area 20 to move the cursor. When the cursor of the mouse moves to an appropriate position and the user needs to click the left mouse button 11 and/or the right mouse button 13, the fingers leave the dragging area 20 and move to the keypad area 10, and click the left/right button just like sending message by telegraph. Actually, a forefinger or another finger including but not limited to a forefinger (another finger, for example, a middle finger) holds down the left mouse button 11 and drags the dragging area 20 to move, thus achieving the operation of selecting areas of conventional mouse. The forefinger holds down the left mouse button 11 and the middle finger holds down the right mouse button 13 simultaneously to move the mouse all around, thus achieving the operation of page turning up, down, left, and right.

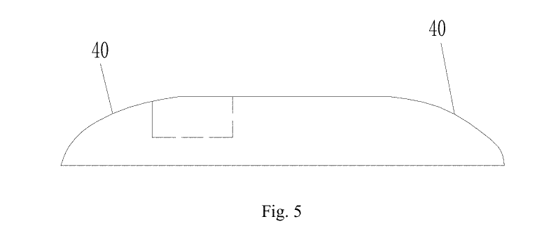

As shown in FIG. 5, edges of the flat shell 30 are arc-shaped, end surfaces and side faces of the flat shell 30 are in the shape of corner rounding to form a rounded arc surface 40, and the rounded arc surface 40 comprises a depressed accommodation groove or a convex supporting boss. Owing to the arrangement of the depressed accommodation groove or the convex supporting boss, when a user operates the mouse, the thumb of the user can be randomly placed on the accommodation groove or the convex supporting boss, thus effectively increasing the placement area of the fingers 22.

### Embodiment 2

As shown in FIGS. 1-2, a flat mouse, comprises: a flat shell 30 comprising, from the top down, a keypad area 10 and a dragging area 20. The keypad area 10 is adapted to be pressed by fingers 22, and the dragging area 20 is adapted to be held down and slided on by the fingers 22. The keypad area 10 comprises a left mouse button 11 and a right mouse button 13. The dragging area is a touch panel 21 capable of controlling the movement of a cursor. In this embodiment, a middle mouse button is disposed between the left mouse button 11 and the right mouse button 13. In addition, the flat shell 30 comprises a mouse electroplate. In use, the fingers 22 of a user move on the touch panel 21 until the cursor of the mouse moves to an appropriate position, and then click the left mouse button 11 or the right mouse button 13 to complete the operation.

In this embodiment, the operation can be achieved using at least two fingers 22, or three to five fingers 22, which are not limited in the embodiment.

In this embodiment, the movement of the cursor can be achieved by sliding the fingers on the touch panel 21 and then click the left mouse button 11 or the right mouse button 13. In the process, only the fingers 22 are involved to slide on the flat mouse, the wrist and elbow are not involved, thus reducing the injury probability of the wrist.

A usage method of the flat mouse, comprises: placing the flat mouse on a plane, placing the palm on the plane and the fingers on the touch panel 21, the left mouse button 11 and the right mouse button 13 being reachable by the fingers; sliding the fingers on the touch panel 21 until the cursor of the mouse moves to an appropriate position, and then pressing the left mouse button 11 and/or the right mouse button 13 using the fingers.

In a relaxed state, the fingers of a user lay flat or naturally curve on the flat mouse. As needed, the fingers are placed on the dragging area 20 and the keypad area 10, and slide on the touch panel 21 to move the cursor. When the cursor of the mouse moves to an appropriate position and the user needs to click the left mouse button 11 and/or the right mouse button 13, the fingers leave the dragging area 20 and move to the keypad area 10, and click the left/right button just like sending message by telegraph. Actually, a forefinger or another finger including but not limited to a forefinger (another finger, for example, a middle finger) holds down the left mouse button 11 and another finger slides on the touch panel 21, thus achieving the operation of selecting areas of conventional mouse. The forefinger holds down the left mouse button 11 and the middle finger holds down the right mouse button 13 simultaneously to move the mouse all around, thus achieving the operation of page turning up, down, left, and right.

As shown in FIG. 5, edges of the flat shell 30 are arc-shaped, end surfaces and side faces of the flat shell 30 are in the shape of corner rounding to form a rounded arc surface 40, and the rounded arc surface 40 comprises a depressed accommodation groove or a convex supporting boss. Owing to the arrangement of the depressed accommodation groove or the convex supporting boss, when a user operates the mouse, the thumb of the user can be randomly placed on the accommodation groove or the convex supporting boss, thus effectively increasing the placement area of the fingers 22.

### Embodiment 3

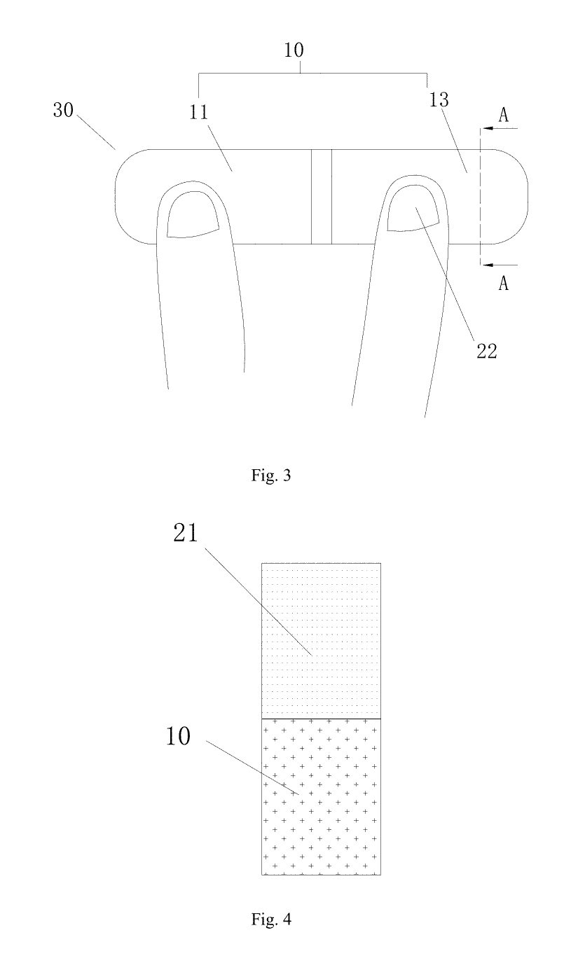

As shown in FIGS. 3 and 4, a flat mouse, comprises: a flat shell 30 comprising a left mouse button 11 and a right mouse button 13 from the top down, surfaces of the left mouse button 11 and the right mouse button 13 being covered with a touch panel 21 capable of controlling the movement of a cursor of the mouse. In this embodiment, a middle mouse button is disposed between the left mouse button 11 and the right mouse button 13. Optionally, no middle mouse button is disposed. In addition, the flat shell 30 comprises a mouse electroplate. In use, a user only needs to slide the fingers on the touch panel 21 of any one of the left mouse button 11 and the right mouse button 13 until the cursor of the mouse moves to an appropriate position, and then click the left mouse button 11 and/or the right mouse button 13 to complete the operation.

In this embodiment, the operation can be achieved using at least two fingers 22, or three to five fingers 22, which are not limited in the embodiment.

In this embodiment, the movement of the cursor can be achieved by sliding the fingers 22 of the user on the touch panel 21, and then click the left mouse button 11 and/or the right mouse button 13. In the process, only the fingers 22 are involved to slide on the flat mouse, the wrist and elbow are not involved, thus reducing the injury probability of the wrist, and being favorable to building up the flexibility of the fingers 22. Conventionally, the touch panels of the notebooks require the fingers to touch and move the cursor, which tends to damage the skin and fingerprint of the fingers. The flat mouse of the invention can solve the problem.

A usage method of the flat mouse comprises: placing the flat mouse on a plane, placing the palm on the plane and the fingers on the left mouse button 11 and the right mouse button 13; sliding the fingers on the touch panel 21 of any one of the left mouse button 11 and the right mouse button 13 until the cursor of the mouse moves to an appropriate position, and pressing the left mouse button 11 and/or the right mouse button 13 using the fingers.

In a relaxed state, the fingers of a user lay flat or naturally curve on the flat mouse. As needed, the fingers are placed on the left mouse button 11 and/or the right mouse button 13, and slide on the touch panel 21 to move the cursor. When the cursor of the mouse moves to an appropriate position and the user needs to click the left mouse button 11 and/or the right mouse button 13, the fingers leave the dragging area 20 and move to the keypad area 10, and click the left/right button just like sending message by telegraph. Actually, a forefinger or another finger including but not limited to a forefinger (another finger, for example, a middle finger) holds down the left mouse button 11 and another finger slides on the touch panel 21, thus achieving the operation of selecting areas of conventional mouse. The forefinger holds down the left mouse button 11 and the middle finger holds down the right mouse button 13 simultaneously to move the mouse all around, thus achieving the operation of page turning up, down, left, and right. The usage method of the flat mouse in this embodiment is something like that of a touch mouse of a notebook. However, the difference lies in that the touch mouse of a notebook is not an external equipment, which means one touch mouse can only match one notebook. In this embodiment, the flat mouse is an external equipment of a computer, which means the flat mouse can be used for matching any corresponding computer. This brings much convenience.

As shown in FIG. 5, which is a side view of a flat mouse in Embodiment 1, 2, or 3 in another shape, edges of the flat shell 30 of the mouse are arc-shaped, thus increasing the contact area of the thumb and the flat mouse. End surfaces and side faces of the flat shell 30 are in the shape of corner rounding to form a rounded arc surface 40, and the rounded arc surface 40 comprises a depressed accommodation groove or a convex supporting boss. Owing to the arrangement of the depressed accommodation groove or the convex supporting boss, when a user operates the mouse, the thumb of the user can be randomly placed on the accommodation groove or the convex supporting boss, thus effectively increasing the placement area of the fingers 22.

It should be noted that, when a user operates any one of abovementioned mouse, as needed, the palm can be placed on the desk or not on the desk.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A flat mouse, comprising: a flat shell (30) comprising, from the top down, a keypad area (10) and a dragging area (20), the keypad area (10) being adapted to be pressed by fingers (22), the dragging area (20) being adapted to be held down by the fingers (22) to drag the flat mouse, and the keypad area (10) comprising a left mouse button (11) and a right mouse button (13).

2. The flat mouse of claim 1, wherein the dragging area (20) and the keypad area (10) are integrated.

3. The flat mouse of claim 2, wherein the dragging area (20) and the keypad area (10) are touch panels (21).

4. A usage method of the flat mouse of claim 1, comprising: placing the fingers on the dragging area (20), the left mouse button (11) and the right mouse button (13) being reachable by the fingers (22); holding down the dragging area (20) and dragging the flat mouse using the fingers until a cursor of the mouse moves to an appropriate position, and pressing the left mouse button (11) and/or the right mouse button (13) using the fingers.

5. A flat mouse, comprising: a flat shell (30) comprising a keypad area (10) and a dragging area (20) from the top down, the keypad area (10) being adapted to be pressed by fingers (22), the dragging area (20) being adapted to be pressed by the fingers (22), the keypad area (10) comprising a left mouse button (11) and a right mouse button (13), and the dragging area (20) being a touch panel (21) capable of controlling the movement of a cursor.

6. A usage method of the flat mouse of claim 5, comprising: placing the fingers on the touch panels (21), the left mouse button (11) and the right mouse button (13) being reachable by the fingers (22); sliding the fingers on the touch panel (21) until the cursor of the mouse moves to an appropriate position, and pressing the left mouse button (11) and/or the right mouse button (13) using the fingers.

7. A flat mouse, comprising: a flat shell (30) comprising a left mouse button (11) and a right mouse button (13) from the top down, surfaces of the left mouse button (11) and the right mouse button (13) being covered with a touch panel (21) capable of controlling the movement of a cursor of the mouse.

8. A usage method of the flat mouse of claim 7, comprising: placing the fingers on the left mouse button (11) and the right mouse button (13); sliding the fingers on the touch panel (21) of any one of the left mouse button (11) and the right mouse button (13) until the cursor of the mouse moves to an appropriate position, and pressing the left mouse button (11) and/or the right mouse button (13) using the fingers.

9. The flat mouse of claim 1, wherein edges of the flat shell are arc-shaped, end surfaces and side faces of the flat shell are in the shape of corner rounding to form a rounded arc surface (40), and the rounded arc surface (40) comprises a depressed accommodation groove or a convex supporting boss.

10. A usage method of the flat mouse of claim 3, comprising: placing the fingers on the dragging area (20), the left mouse button (11) and the right mouse button (13) being reachable by the fingers (22); holding down the dragging area (20) and dragging the flat mouse using the fingers until a cursor of the mouse moves to an appropriate position, and pressing the left mouse button (11) and/or the right mouse button (13) using the fingers.

11. The flat mouse of claim 2, wherein edges of the flat shell are arc-shaped, end surfaces and side faces of the flat shell are in the shape of corner rounding to form a rounded arc surface (40), and the rounded arc surface (40) comprises a depressed accommodation groove or a convex supporting boss.

12. The flat mouse of claim 3, wherein edges of the flat shell are arc-shaped, end surfaces and side faces of the flat shell are in the shape of corner rounding to form a rounded arc surface (40), and the rounded arc surface (40) comprises a depressed accommodation groove or a convex supporting boss.

13. The flat mouse of claim 5, wherein edges of the flat shell are arc-shaped, end surfaces and side faces of the flat shell are in the shape of corner rounding to form a rounded arc surface (40), and the rounded arc surface (40) comprises a depressed accommodation groove or a convex supporting boss.

14. The flat mouse of claim 7, wherein edges of the flat shell are arc-shaped, end surfaces and side faces of the flat shell are in the shape of corner rounding to form a rounded arc surface (40), and the rounded arc surface (40) comprises a depressed accommodation groove or a convex supporting boss.
